(19) United States
(12) Patent Application Publication
(10) Pub. No.: US 2012/0304513 A1
(43) Pub. Date: Dec. 6, 2012

(54) ILLUMINATED DEVICE

(76) Inventor: Scott P. Gorelick, Los Angeles, CA (US)

(21) Appl. No.: 13/149,350

(22) Filed: May 31, 2011

(51) Int. Cl. G09F 13/00; G09F 15/00

(52) U.S. Cl. 40/581; 40/606.19; 40/541

(57) ABSTRACT

An illuminating device is provided, including a first informational block and a second informational block. The first informational block may include an informational communication. The informational communication may include at least one graphic illustration having a defined graphic area. The panel may be positioned such that at least a portion of the informational communication is substantially visible through the viewing plane. The second informational block may include a sponsor communication. The information blocks may be encompassed by a frame and be illuminated by a light emitting source within the frame.

### TECHNICAL FIELD

The present disclosure relates to an illuminating device and in particular to an illuminating device including an informational communication and a separate sponsor communication.

### BACKGROUND

Consumer goods and services are often evaluated to measure their level of quality, value, or safety. In particular, restaurants may be evaluated using a rating scale to indicate their level of dining experience or culinary merit. Consumers typically use these ratings as a factor to consider when selecting a dining establishment. The level of sanitation or cleanliness in a restaurant may also be a factor considered by a consumer when selecting a restaurant as well. However, even though restaurants may be routinely inspected by a local health department, it is often difficult for a consumer to find out the results of a restaurant's sanitation inspection.

In response to this concern, some local governments and health departments have established a rating system that indicates the level of sanitation in a restaurant. The rating system generally includes a letter or number that designates the results of an inspection. In one example, a certificate may be issued by the local government or health department to restaurants with the results of the inspection.

Some local governments may require the certificate to be prominently displayed near, in or outside the dining establishment in an effort to inform consumers of the level of sanitation in the restaurant. The certificate may include the restaurant's rating in large or oversized font such that the rating may be easily seen at a distance. If a restaurant has earned a favorable rating, then it might be especially desirable to emphasize the rating in a way to catch the attention of potential consumers. Bringing the rating to the attention of a consumer may be especially challenging at dusk or nighttime, as a lack of natural light may make the certificate difficult to see.

Therefore, there exists a need to provide a device that displays a certificate and allows for a portion of the certificate be highlighted in an effort to attract the attention of a consumer.

### BRIEF DESCRIPTION OF THE DRAWINGS

FIG. 1 is a partially exploded view of an illuminating device;

FIG. 2A is a front view of the illuminated device unlighted;

FIG. 2B is a front view of the illuminated device lighted;

FIG. 3A is a perspective view of a panel of the illuminated device including an indicia that is created by a coating;

FIG. 3B is a perspective view of an alternative illustration of the panel in FIG. 3A, where the indicia is created by a recess in the panel;

FIG. 4A is a partially exploded view of an alternative illustration of an illuminating device;

FIG. 4B is a front view of the illuminated device in FIG. 4A unlighted;

FIG. 4C is a front view of the illuminated device in FIG. 4B lighted;

FIG. 5 is an alternative illustration of an illuminating device including a secondary information block; and

FIG. 6 is a partially exploded view of an illuminating device in FIG. 5.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

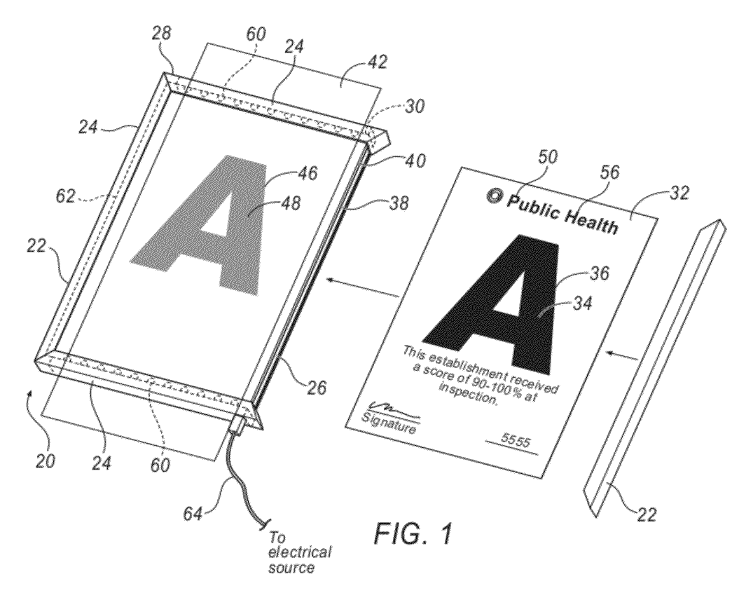

FIG. 1 illustrates a partially exploded view of an exemplary illuminating device 20 illustrated as a picture frame. The illuminating device 20 includes at least one light emitting source 30 and an informational communication 32. The informational communication 32 includes at least one graphic illustration 34 with a defined graphic area 36. The illuminating device 20 also includes an optically transmissive panel 40 having a viewing plane 42.

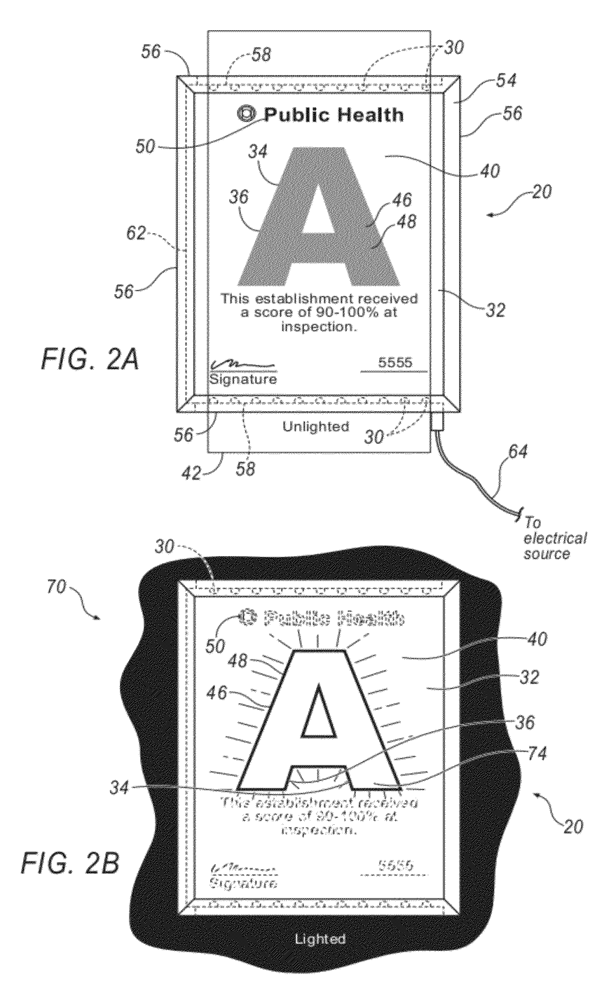

Turning to FIGS. 2A-2B, when the illuminating device is assembled, the panel 40 and the informational communication 32 may be positioned in relation to each other such that at least a portion of the informational communication 32 is substantially visible through the viewing plane 42. The panel 40 includes a light absorbing indicia 46 adjacent to and oriented at the viewing plane 42 of the panel 40, where the indicia 46 includes an illuminated area 48 that is selectively illuminated by the light emitting source 30. Indicia 46 may be secured to panel 40 and in some situations may be secured through integration with the panel 40. The indicia 46 generally correspond with at least a portion of the graphic area 36 of the graphic illustration 34. The informational communication 32 and the panel 40 are positioned in relation to each other such that the illuminated area 48 generally corresponds with at least a portion of the graphic area 36 of the graphic illustration 34. Turing to FIG. 2B, which is an illustration of the illuminated device 20 lighted, the graphic area 36 of the informational communication 32 may be selectively illuminated by the indicia 46, thereby bringing emphasis to the graphic illustration 34.

The informational communication 32 may also include secondary graphics 50 that are substantially visible through the viewing plane 42 of the panel 40. The secondary graphics 50 may remain unilluminated even when the illuminating area 48 is lighted by the indicia 46. In one exemplary illustration, the graphic illustration 34 represents a symbol that is of particular interest to a consumer. For example, the graphic illustration 34 could be a rating for consumer goods or services such as a letter, number grade or a series of stars (i.e. a four star restaurant). The secondary graphics 50 may be information or illustrations about the graphic illustration 34. In one illustration, the secondary graphics 50 may be the logo or trademark of a corporate sponsor who is responsible for purchasing and distributing the illuminated device 20. In another illustration, the secondary graphics 50 may convey information that is of less importance to a consumer than the graphic illustration 34. For example, the secondary graphics 50 may represent the entity responsible for preparing the rating that is the graphic illustration 34. Because the graphic illustration 34 represents information that may be of greater importance than the secondary graphics 50, the graphic illustration 34 may be illuminated by the indicia 46 in an effort to place emphasis on the graphic illustration 34. Alternatively, the indicia 46 may generally correspond to the graphic illustration 34. When informational communication 32 is properly installed as shown in FIGS. 2A-2B the indicia 46 is positioned in front of graphic illustration 34 such that the defined graphic area 36 is subsumed by the corresponding graphic area 48 of indicia 46.

In a first approach the graphic illustration 34 represents information that is of particular interest to a consumer, and the graphic illustration 34 itself is highlighted. In contrast, the secondary graphics 50, which contain information that may be of less importance than the graphic illustration 34, are typically not illuminated. In a second approach the indicia 46 itself is highlighted, but it appears as if it is the graphic illustration 34 that is highlighted since they generally correspond to one another and may be essentially identical. Once again, however, the secondary graphics 50, which contain information that may be of less importance than that corresponding to indicia 46 and graphic illustration 34, are typically not illuminated. In a third approach both the graphic illustration and the indicia 46 are highlighted, mutually reinforcing each other from the perception of a remote observer.

Turning back to FIG. 1, the illuminated device 20 may be a picture frame at least partially containing the informational communication 32. The illuminated device 20 may include a frame 22 positioned along edges 24 of the illuminated device 20, where the frame 22 may substantially enclose an outer periphery 28 of the panel 40. FIG. 1 illustrates the frame 22 with removable portions, where a portion of the frame 22 at one of the edges 24 is removed to expose an opening 38 created between the panel 40 and a backing 26. However, it should be noted that the frame 22 may be omitted from the illuminated device 20 as well.

The informational communication 32 may be selectively inserted within the opening 38, between the panel 40 and the backing 26. The medium representing informational communication 32 may be any type of instrument including at least one graphic illustration 34, such as, for example, paper or cloth. In one illustration, the medium of informational communication 32 could be a sheet of paper, where the graphic illustration 34 may be printed on the paper. Alternatively, in another illustration the medium of the informational communication 32 could be cloth, where the graphic illustration 34 is woven into the medium of the informational communication 32. The medium of the informational communication 32 may also be an electronic display such as a Liquid Crystal Display (LCD) or Light Emitting Diode (LED) panel or panels. The electronic display may fit entirely within the frame, eliminating the need for the panel 40 and backing 26, or may fit within the opening 38 between the panel 40 and backing 26.

While the illuminated device 20 is illustrated as a picture frame, any device capable of at least partially containing or positioning the informational communication 32 may be used. For example, in an alternative illustration the illuminated device 20 may be a picture cube. In another illustration, the illuminated device 20 may be part of a countertop display, where the upper surface of the countertop is the panel 40. The illuminated device 20 may also be placed on a stand such as an easel-type stand or a post.

FIG. 1 shows the graphic illustration 34 as the letter “A”. However, it should be noted that the graphic illustration 34 may be any marking on the informational communication 32 that includes a defined graphic area 36. That is, the graphic illustration 34 may be any marking including a definable periphery. For example, the graphic illustration 34 may be any letter of the alphabet, or a number. In another example the graphic illustration 34 may be an ornamental design, such as, for example, a star. The secondary graphics 50 may also be any marking on the informational communication that includes a definable area 56, such as, but not limited to, lettering, numbering or an ornamental design.

The light emitting source 30 may be any device that selectively transmits visible light towards the direction of the indicia 46. In one illustration the light emitting source 30 may be a series of light emitting diodes (LEDs) facing the indicia 46. The light emitting source 30 may be positioned along at least one edge 24 of the illuminated device 20, between the panel 40 and the backing 26. In one example, the light emitting source 30 is a series of LEDs positioned along two opposing edges 24 of the frame 22. At least one circuit board 60 may be included for providing power to the LEDs. In the illustration as shown, the illuminated device 20 includes two circuit boards 60 providing power to the LEDs, where the circuit boards 60 are located on the opposing edges 24. Wiring 62 may be included between the edges 24 of the illuminated device 20 to communicate electrical power. A power cord 64 may provide power to the circuit boards 60, where the power cord is in electrical communication with an electrical source, such as a power outlet. Although FIGS. 1-2B illustrate the power cord 64 positioned along a bottom edge 24 of the picture frame 22, the power cord 64 may be positioned at any location on the illuminated device 20 where power can be communicated to the circuit boards 60.

In addition or in the alternative to the power cored 64, other devices may provide power to the circuit board 60. For example, the circuit board 60 may be powered by an energy storage device such as a battery. Solar power may also be used to provide power to the circuit board. In this example, the picture frame 22, or some other portion of the device 20, may include solar panels or photovoltaics which convert light into electricity. The electricity may provide power to the circuit board 60 which in turn illuminates the light emitting source 30.

The frame 22 may at least partially conceal the circuit boards 60, the light emitting source 30 and the wiring 62 from view through the panel 40. The frame 22 may include decorative finishes. These decorative finishes may be removable or replaceable, such that a user may change the finishes as he or she pleases. The frame 22 may be removable or replaceable so that the aesthetic look of the illuminated device 20 may be modified from time to time. Moreover, the frame may be magnetic and magnetic decorations, advertisements, photos, etc. may be attached to the frame 22.

The panel 40 may be any generally transparent panel that allows for the secondary graphics 50 to be substantially visible through the viewing plane 42 when the illuminated device 20 is assembled, as shown in FIG. 2A. The panel 40 may be constructed from a polymer such as, for example, acrylic and Plexiglas®. The panel 40 may be optically transmissive such that visible light transmitted from the light emitting source 30 may be communicated to the indicia 46, thereby causing the indicia 46 to be illuminated. The light transmitted from the light emitting source 30 may selectively illuminate portions of the panel 40. That is, as seen in FIG. 2B, the indicia 46 may be selectively illuminated by the light emitting source 30, while the remaining portions of the panel 40 remain unlit. Thus, the indicia 46 may generally be the only portion of the panel illuminated by the light emitting source 30.

Turing back to FIG. 2A, the illuminated device 20 is shown unlighted, where the light emitting source 30 does not generally transmit light through the panel 40 and to the indicia 46. FIG. 2A also illustrates the illuminated device 20 assembled, where the informational communication 32 has been inserted into the opening 38 (as seen in FIG. 1) and the portion of the frame 22 that was removed (as seen in FIG. 1) is inserted along the edge 24. When the illuminated device 20 is assembled, the panel 40 may be positioned in relation to the informational communication 32 such that at least a portion of the informational communication 32 is substantially visible through the viewing plane 42 of the panel 40. That is, the secondary graphics 50 may be generally visible through the viewing plane 42.

The informational communication 32 and the panel 40 may be positioned in relation to each other such that the illuminated area 48 generally corresponds with at least a portion of the graphic area 36 of the graphic illustration 34 with respect to the viewing plane 42, and the illuminated area 48 at least partially covers the graphic illustration 34. That is, the illuminated area 48 of the indicia 46 may be about the same size and shape as the graphic area 36 of the graphic illustration 34. In the exemplary illustration of FIG. 1, the indicia 46 is in the shape of a letter “A”, and generally matches the shape and size of the letter “A” of the graphic illustration 34 printed on the informational communication 32. Turning back to FIG. 2A, when the illuminated device 20 is assembled, the graphic illustration 34 may be generally aligned with the indicia 46 to at least partially hide the graphic illustration 34 from view through the panel 40. In the illustration of FIGS. 2A-2B, the graphic illustration 34 is substantially hidden from view by the indicia 46. However, because the indicia 46 may be about the same size and shape as the graphic illustration 34, when the panel 40 is illuminated the glowing indicia 46 generally indicates where at least a portion of the graphic area 36 may be located on the informational communication 32.

FIG. 2B is an illustration of the illuminated device 20 when the light emitting source 30 is electrified, thereby lighting the illuminated device 20. When lit, the illuminated device 20 illuminates the indicia 46, and typically does not generally illuminate the secondary graphics 50. The arrangement of lighting only the indicia 46 may be done in an effort to highlight the graphic illustration 34 as discussed above. Alternatively, as also discussed above, the lighting of the indicia 46 acts as a substitute for the graphic illustration 34, which is essentially covered by the corresponding and essentially matching indicia 46. In a further example, both indicia 46 and graphic illustration 34 may be simultaneously observed in a reinforcing manner. In any of the three exemplary illustrations, however, the indicia 46 and/or graphic illustration 34 may be one or more characters (e.g., letters, numbers, or starts) that signify something of importance, and in particular a communication that is of greater importance than the secondary graphics 50. Therefore, illuminating the indicia 46 alone or in combination with graphic illustration 34 highlights the graphic illustration 34 such that the graphic illustration 34 or its stand-in in the form of the indicia 46 may be the main focal point of the informational communication 32.

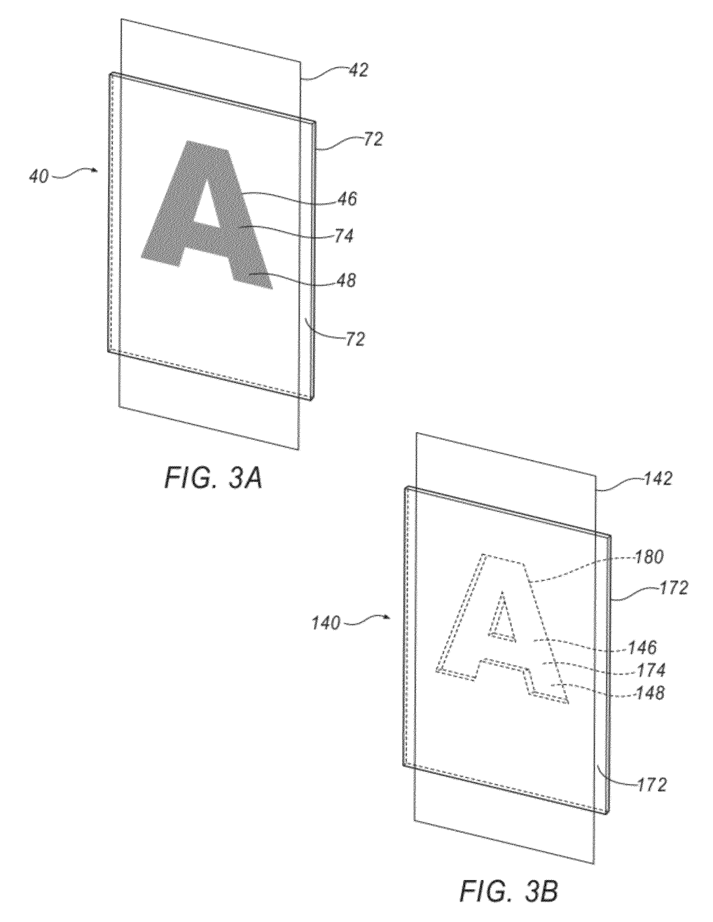

FIG. 2B illustrates the illuminated device 20 in an environment 70 where there is limited outside light. Illuminating the indicia 46 in the environment 70 with limited light may tend to highlight or emphasize the graphic illustration 34 more than in an environment that is well-lit. In one example, the light emitting source 30 may be a colored light, and the indicia 46 is created by a light absorbing coating that is painted on the panel 40, such as a coating 74 illustrated in FIG. 3A. The light absorbing coating 74 may include a pigment. It may be desirable for the pigment to correspond to the actual color of graphic illustration 34 such that the color of the graphic illustration is highlighted and reinforced when indicia 46 is lit.

Turning back to FIG. 2B, in one illustrative example, the color of the light from the light emitting source 30 may generally match the pigment of the light absorbing coating 74. More particularly, the light emitting source 30 may be a series of colored LED lights, such as, for example, blue LEDs. The coating 74 may include a blue pigment that generally corresponds to the color of the blue LEDs. Matching the coloring of the lighting and the pigment together may enhance the overall lighting effect of the illuminated device 20, making the illuminated device 20 more aesthetically pleasing. Although blue LEDs and a blue pigment is discussed, the light emitting source 30 and the light absorbing coating 74 may be any color, such as, for example, pink, purple, green, red, or yellow. Moreover, in another example the color of the light emitting source 30 may be different from the pigment of the light absorbing coating 74.

Turning to FIG. 3A, the panel 40 may include opposing faces 72 that are located along the viewing plane 42, where the light absorbing coating 74 may be applied to one of the faces 72. In this example, substantially all of the indicia 46 may be the illuminated area 48. That is, generally the entire area of the indicia 46 may be illuminated by the light emitting source 30 (illustrated in FIGS. 1 and 2A-2B). Alternatively, FIG. 3B illustrates a panel 140 including an indicia 146 created by a recess 174 that is located along a face 172 of the panel 140. The recess 174 may be created by carving or engraving one of the faces 172 of the panel. In this illustration, the only an outer periphery 180 of the indicia 146 may be an illuminated area 148. In other words, only a portion of the indicia 146 may be illuminated by the light emitting source 30.

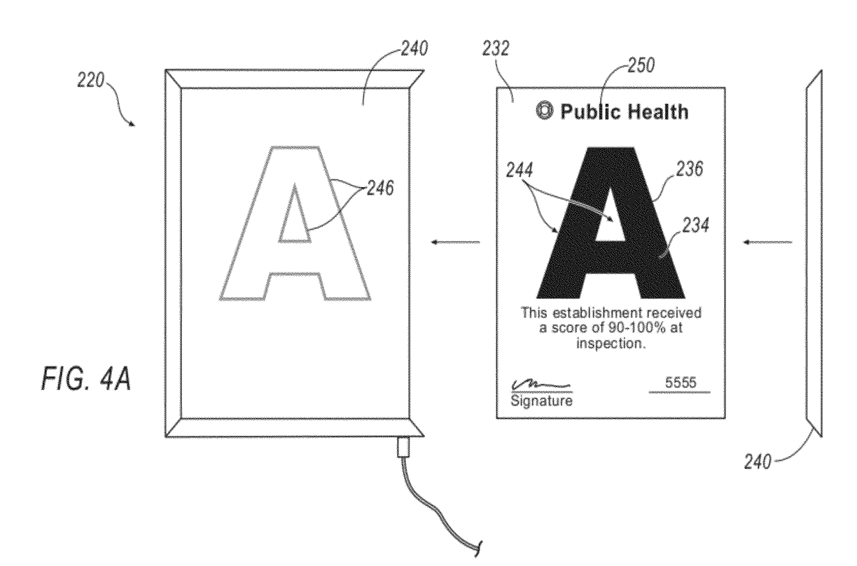

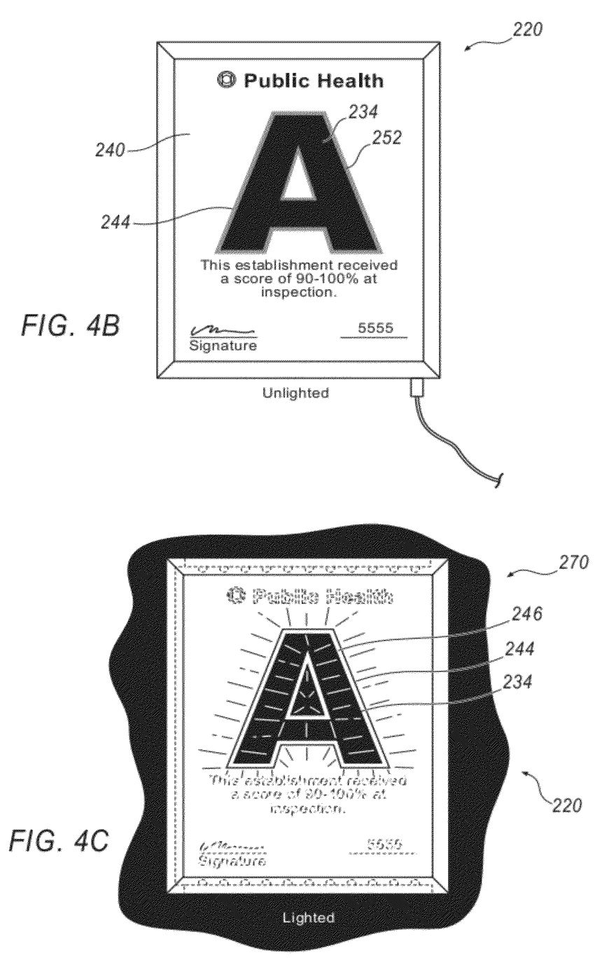

FIGS. 1-2B illustrate the illuminated area 48 of the indicia 46 corresponding to substantially the entire portion of the graphic area 36 of the graphic illustration 34. That is, the illuminated area 48 of the panel 40 generally covers the entire graphic illustration 34. FIGS. 4A-4B show an alternative illustration of an illuminated device 220. Turning to FIG. 4A, which is a partially exploded view of the illuminated device 220, an informational communication 232 is illustrated as generally the same informational communication 32 illustrated in FIGS. 1-2B, with a graphic area 236, a graphic illustration 234 and secondary graphics 250. A panel 240 of the illuminated device 20 includes indicia 246 that correspond with an outer periphery 244 of the graphic illustration 234. Unlike the indicia 46 illustrated in FIGS. 1-2B, the indicia 246 of FIG. 4A does not cover substantially the entire portion of the graphic area 236 of the graphic illustration 234. Instead, the indicia 246 only correspond with at least a portion of the outer periphery 244 of the graphic illustration 234.

Turning to FIG. 4B, when the illuminated device 220 is assembled, a portion of the graphic illustration 234 may be seen though the panel 240. However, FIG. 4B illustrates the outer periphery 244 of the graphic illustration 234 hidden from view. FIG. 4C illustrates the illuminated device 220 lighted, and placed in an environment 270 that includes limited lighting. When the illuminated device 220 is lighted, the outer periphery 244 of the graphic illustration 234 may be illuminated, while the remaining portion of the graphic area 236 remains unlighted.

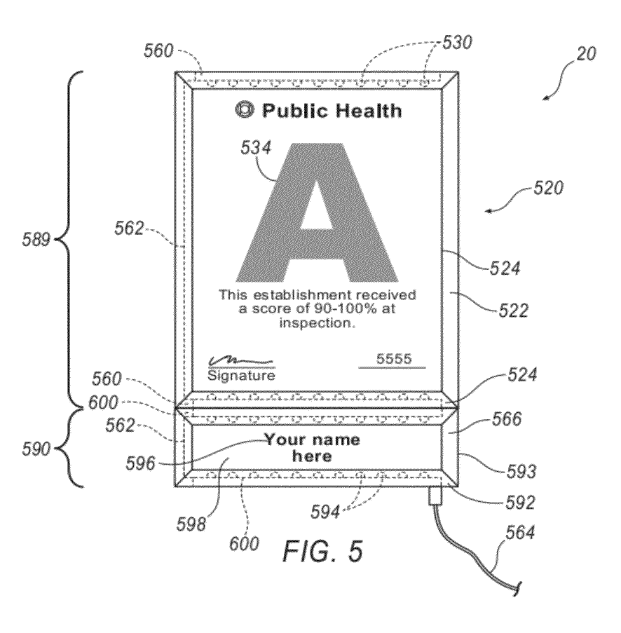

In one example of an illuminated device, a corporate sponsor, business establishment, or an individual may be responsible for purchasing and distributing the illuminated device. FIG. 5 illustrates an illuminated device 520 with a first information block 589 containing the informational communication 532 within the main frame portion 522 and a second information block 590 containing the name, logo, trademark, or any other desired information regarding the sponsor responsible for distributing the illuminated device 520. In one example, the sponsor may purchase and distribute the illuminated device 520 to dining establishments at a reduced cost or free of charge. In exchange, the dining establishment may display the illuminated device 520, where the second information block 590 serves as an advertisement space for the sponsor. In additional to dining establishment, any type of building or business may display the illuminated device. As discussed herein, a health department may rate certain establishments. This may include any building or location that has a facility that is rated by a governing agency. This list may include, but is not limited to, restaurants, supermarkets, grocery stores, convenience stores, liquor stores, gas stations, cafeterias, concessions stands, mobile food trucks, mobile catering facilities, retail kitchens, retail food markets, etc. Moreover, other departments may supply ratings for entities. For example, a school may be rated by the Department of Education. The school may then display the school's rating in the first information block 589 of the illuminated device 520. A hotel may also display its rating, such as its AAA rating, or the like. The second information block 590 includes a second frame portion 593 surrounding a sponsor communication such as a graphic logo 596 representing the sponsor of the illuminate device 520.

The second frame portion 592 includes a second side frame 593 attached along a second edge 566. The first information block includes the main frame portion 522, or first frame portion, containing a graphic illustration 534. A first light emitting source 530 may be included to illuminate the secondary graphic 534 of the main frame portion 522, and the secondary frame portion 592 may include a second light emitting source 594. Both of the first and second light emitting sources 530 and 594 may be a series of LEDs, and in one illustration the first light emitting source 530 may be separate from the second light emitting source 594. The second light emitting source 594 may be used to illuminate a sponsor communication 596 located within the second frame portion 592. In one exemplary illustration, the LEDs used to light the graphic illustration 534 may be of a different color or intensity than the LEDs used to light the sponsor communication 596. Specifically, if the sponsor communication 596 represents a corporate sponsor whose products are typically packaged in a particular hue or shade of red or yellow, then the LEDs used to illuminate the sponsor communication 596 may be selected accordingly, while the LEDs used to light the graphic illustration 534 may be of a different color.

The sponsor communication 596 may be created by applying a light absorbing coating to a panel 598 of the second frame portion 592, however the sponsor communication 596 may also be created by a recess within the panel 596 as well. In an alternative approach, the second frame portion 592 may be unlit and does not include the second light emitting source 594.

In this illustration, a first set of circuit boards 560 provide power to the LEDs 530 to illuminate the graphic illustration 534, and two circuit boards 600 provide power to the LEDs 594 to illuminate the sponsor communication 596. A power cord 564 may provide power to the circuit boards 560 and 600. Wiring 562 may be included between the first set of circuit boards 560 and the second set of circuit boards 600 to communicate electrical power. Other approaches may be used as well to communicate power and light within the illuminated device 520. For example, the first light emitting source 530 and the second light emitting source 594 may share a circuit board.

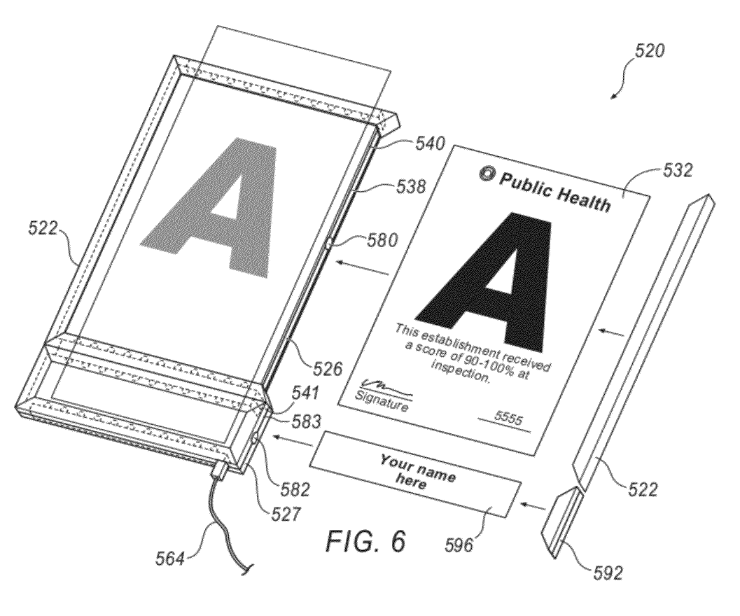

FIG. 6 illustrates a partially exploded view of the illuminated device 520 with the first information block 589 and the second information block 590. As shown in FIG. 1, the main frame portion 522 may be removable to expose a first opening 538 created between a first panel 540 and a first backing 526. Additionally, the second frame portion 592, as described above, may also be removable to expose a second opening 583 between a second panel 541 and a second backing 527. In another example, the main frame portion 522 and second frame portion 592 may be formed as a single piece, exposing both the first opening 538 and the second opening 583.

The first panel 540 and first backing 526 may form a first notch 580. The first notch 580 may be formed from a recess on both the first panel 540 and first backing 526 such that when the informational communication 532 is inserted between the first panel 540 and first backing 526, as shown in FIG. 5, at least a portion of the informational communication is accessible at the first notch 580, allowing for the informational communication 532 to be easily removed. Additionally, second panel 541 and second backing 527 may similarly form a second notch 582 for exposing a portion of the sponsor communication 596.

The second side frame 593 at the edge 566 is shown as being removable, but any portion of the main frame portion 522 or second frame portion 592 may be removable. The frames 522 and 592 may be held in place over the panels 540 and 541 by friction. Alternatively or additionally, the frames 522 and 592 may be held in place by some form of locking mechanism or fastening device.

In one illustrative example, a dining establishment or other provider of goods or services may be rated by an agency to indicate the level of quality, value or service. If the establishment earns a favorable rating, the provider of goods or services may wish to bring this rating to the attention of a potential consumer. The illuminated device 20 may be used to highlight the favorable rating. In this example, referring generally to FIGS. 1-2B and FIGS. 4A-6, the informational communication 32 may be a certificate or other type of documentation signifying the favorable rating. In particular, the letter “A” that is the graphic illustration 34 represents the rating, where “A” is the highest possible rating that may be earned. The certificate may be placed within the illuminated device 20, where the indicia 46 generally correspond to the favorable rating printed on the certificate. When illuminated, the indicia 46 highlights and emphasizes the “A” printed on the certificate. The illuminated device 20 may then be placed in a location such as a window or the storefront of the establishment to attract the attention of at least some potential consumers.

As explained above with respect to the informational communication 32, the sponsor communication 596 may also be an electronic display, such as an LCD display or LED panel. The informational communication 32 and sponsor communication 596 display may be updated remotely. For example, a health department may change an establishment's rating or level of sanitation. In this case, instead of manually updating the informational communication to include the new rating, i.e. updating the graphic illustration 34 from ‘B’ to ‘A’, the heath department could change the rating remotely, by sending a signal to the illuminated device 20 and without visiting the establishment, or having a user at the establishment change the informational communication. Moreover, this may aid in keeping the illuminated device 20 up to date with the most recent rating. In another example, different departments within and across different locations may use different color variations to represent specific ratings. For example, the health department of California may use blue letters to display the ratings of establishments whereas New York may use red numbers, etc. Thus, an electric version of the display may allow for changes in the appearance of a rating, in addition to the actual rating itself.

The sponsor communication 596 may also be updated remotely. For example, if a sponsor wishes to change the graphic illustration 534, the sponsor could send a signal to all the signs sponsored by the sponsor, and update the illustration 534 concurrently. Thus, all of the signs under the sponsors control would be consistent. Moreover, the owner of the sign may be an entity separate from the sponsor. In the event that a sponsor has changes, i.e. a sponsor has decided to no longer sponsor the sign, and thus the graphic illustration 534 representing that sponsor should be removed, the owner may remove the graphic illustration 534 such that there is nothing displayed in the second information block 590, or that a new graphic illustration 534 representing a new sponsor is displayed in the second information block 590.

The illuminated device 520 may be capable of connecting to a communication network via wireless technology, or may be connected to a router via a cable. The communication network may include wireless networks such as 3G and 4G networks, and Bluetooth technologies. The illuminated device 20 may receive a message or signal indicating that the informational communication 532 or graphic illustration 534 is to be updated. Additionally, the illuminate device 20 may include a hardware receptacle (not shown) for receiving a data storage device such as a USB flash drive, SD card, DVD or CD discs, etc. The data on these data storage devices may update the informational communication 532 and/or graphic illustration 534.

It should be noted that the illuminating device 20 may also be used in a variety of other applications as well. For example, the informational communication 32 may be a decorative print, where the graphic illustration 34 is a particular area of the print that might be considered the most aesthetically pleasing portion of the print. The illuminating device 20 may illuminate the graphic illustration 34 that is supposed to be the most interesting or pleasing portion of the print, thereby enhancing the overall effect of the decorative print.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. An informational display, comprising:
a frame surrounding an information block;
an informational communication disposed within the information block; and
a sponsor communication disposed within the information block and adjacent to, but separate from the informational communication, wherein at least one portion of the frame is removable to allow each of the informational communication and sponsor communication to be separately and selectively inserted in the frame.

2. The informational display as set forth in claim 1, wherein the sponsor communication includes a graphic logo representing a sponsor of the informational display.

3. The informational display as set forth in claim 1, wherein the information block includes a first information block having a first optically transmissive panel positioned such that at least a portion of the informational communication is substantially visible through the panel.

4. The informational display as set forth in claim 3, wherein the frame includes a first frame enclosing an outer periphery of the first panel and a first backing, the informational communication being selectively inserted in a first opening formed between a first backing and the first panel.

5. The informational display as set forth in claim 4, wherein the outer periphery of each of the first panel and the first backing defines a first notch for exposing at least a portion of the informational communication inserted in the first opening.

6. The informational display as set forth in claim 1, wherein the information block includes a second information block having a second optically transmissive panel positioned such that at least a portion of the sponsor communication is substantially visible through the panel.

7. The informational display as set forth in claim 6, wherein the frame includes a second frame enclosing an outer periphery of the second panel and a second backing, the sponsor communication being selectively inserted in a second opening formed between a second backing and the second panel.

8. The informational display as set forth in claim 7, wherein the outer periphery of each of the second panel and the second backing defines a second notch for exposing at least a portion of the informational communication inserted in the second opening.

9. The informational display as set forth in claim 1, wherein the informational communication includes at least one graphic illustration representing at least one rating of an establishment.

10. The informational display as set forth in claim 1, further comprising a first light emitting source disposed within the first frame for illuminating at least a portion of the informational communication.

11. The informational display as set forth in claim 1, further comprising a second light emitting source disposed within the second frame for illuminating at least a portion of the sponsor communication.

12. The informational display as set forth in claim 1, wherein the informational communication and sponsor communication form a single digitally updatable device.

13. The informational display as set forth in claim 1, wherein the frame includes a digital receptacle for receiving a data storage device.

14. The illuminating device of claim 1, wherein the informational communication includes at least one graphic illustration that is at least one of a letter of the alphabet and a number.

15. An illuminating device, comprising:
at least one light emitting source;
an informational communication including at least one graphic illustration and at least one secondary graphic, the at least one graphic illustration having a defined graphic area;
an optically transmissive panel including a viewing plane, the panel positioned such that at least a portion of the informational communication and the secondary graphic are substantially visible through the viewing plane; and
a light absorbing indicia secured to the panel, the indicia including an illuminated area selectively illuminated by the light emitting source;
wherein the informational communication and the panel are positioned in relation to one another such that the illuminated area generally corresponds with at least a portion of the graphic area of the at least one graphic illustration with respect to the viewing plane, and the illuminated area at least partially covers the graphic illustration;
wherein the illuminated area generally indicates where at least a portion of the graphic area is located on the informational communication; and
wherein the secondary graphic is unilluminated when the illuminated area is lighted.

16. The illuminating device of claim 15, wherein the at least one light emitting source is a series of LEDs.

17. The illuminating device of claim 15, wherein the indicia is a light absorbing coating that is located on a face of the panel along the viewing plane.

18. The illuminating device of claim 17, wherein the coating includes a pigment and the LEDs include a color, and the pigment of the coating generally matches the pigment of the LEDs.

19. The illuminating device of claim 15, wherein the entire indicia is the illuminated area.

20. An informational display, comprising:
a first information block surrounded by a first frame and including a first optically transmissive panel, the first frame enclosing an outer periphery of the first panel;
a second information block surrounded by a second frame and including a second optically transmissive panel, the second frame enclosing an outer periphery of the second panel and at least a portion of the first frame being in communication with a portion of the second frame;
a first backing disposed within the first frame and abutting and aligning with the first panel, the first backing and first panel forming a first opening there between and defining a first notch at a periphery of the first panel and the first backing for exposing at least a portion of the first opening;
an informational communication including at least one graphic illustration representing at least one rating of an establishment, the informational communication being selectively inserted in the first opening;
a second backing disposed within the second frame and abutting and aligning with the second panel, the second backing and second panel forming a second opening there between and defining a second notch at a periphery of the second panel and the second backing for exposing at least a portion of the second opening;
a sponsor communication representing a sponsor of the informational display and being selectively inserted in the second opening;
a first light emitting source disposed within the frame for illuminating at least one of the first information block and the second information block; and
wherein at least one portion of the first and second frames is removable to expose the first and second openings.
